(19) United States
(12) Patent Application Publication
(10) Pub. No.: US 2011/0021320 A1
(43) Pub. Date: Jan. 27, 2011

(54) GAIT ENHANCED LEARNING DEVICE AND METHOD

(76) Inventor: Martin L. Lenhardt, Hayes, VA (US)

Correspondence Address: Hershkovitz & Associates, LLC, 2845 Duke Street, Alexandria, VA, 22314, US

(21) Appl. No.: 12/811,828

(22) PCT Filed: Jan. 6, 2009
(86) PCT No.: PCT/US09/30195

§ 371 Date: Oct. 1, 2010

Related U.S. Application Data
(60) Provisional application No. 61/019,450, filed on Jan. 7, 2008.

(51) Int. Cl. A63B 23/04; G09B 19/04

(52) U.S. Cl. 482/9; 434/185

(57) ABSTRACT

The present invention relates to a device for rhythm pacing using a real time recording of stepping (or speech motor production) with a radiowave (speed of light) connection to a head-mounted device. The rhythm is initiated with the patient's initial performance and increased by increments to entrain motor skill. By automating the pulsing in a fashion that reflects real time stepping, trial and error can be avoided, yielding efficient learning and gait improvement.

### CROSS REFERENCE TO RELATED APPLICATION

This application claims priority to the provisional application filed by Martin Louis Lenhardt for the invention of the same name and mailed on Jan. 7, 2008 and corresponding to U.S. 61/019,450.

BACKGROUND OF THE INVENTION

Field of Invention

The present invention relates to a device for rhythm pacing using a real time recording of stepping (or speech motor production) with a radiowave (speed of light) connection to a head-mounted device.

Bipedalism, or walking upright on two feet was the likely reason for human brain expansion among the primates. The sensory and motor controls involve many cortical and subcortical centers. In cases of disease, trauma, and aging these centers can be compromised and walking may be impaired. The gait of older people differs from the young especially in stride length (FIG. 1.) [Ochs et al, 1985]. Shorter gait will lead the motor cortex to reprogram, such that short steps will be the noun. Short steps have the disadvantage of changing the center of gravity by inducing an ankle strategy in trying to maintain balance rather than a hip balance strategy. The former is a major contributor to falls in the elderly (FIG. 2).

Gait can be improved with therapy, Thaut and coworkers have demonstrated that listening to rhythmic auditory cues can improve stride (entrain higher stride rates by synchronizing auditory rhythms to step patterns). Stride length has been reported to increase by 12% in Parkinson patients; 29% in traumatic brain injury patients and over 50% in stroke patients. Therapy was also effective in Huntington's chorea. Auditory rhythm can guide motor acts after three weeks of training. Therapy was provided by a metronome or recorded musical beats. The timing was estimated from the patient's gait.

### BRIEF DESCRIPTION OF THE FIGURES

FIG. 1 illustrates the effect of age on gait;

FIG. 2 illustrates balance strategies;

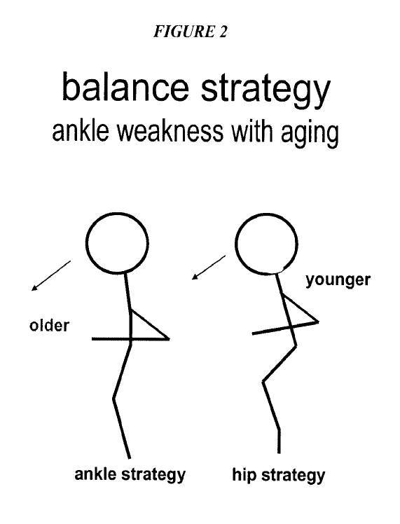

FIG. 3 illustrates the “smart stepper”; and

FIG. 4 illustrates the speech aid.

### DESCRIPTION OF THE INVENTION

The present invention allows for real time recording of stepping with radiowave (speed of light) connection to a head mounted device for rhythm pacing. The rhythm is initiated with the patient's initial performance and increased by increments to entrain motor skill. By automating the pulsing in a fashion that reflects real time stepping, trial and error can be avoided yielding efficient learning and gait improvement.

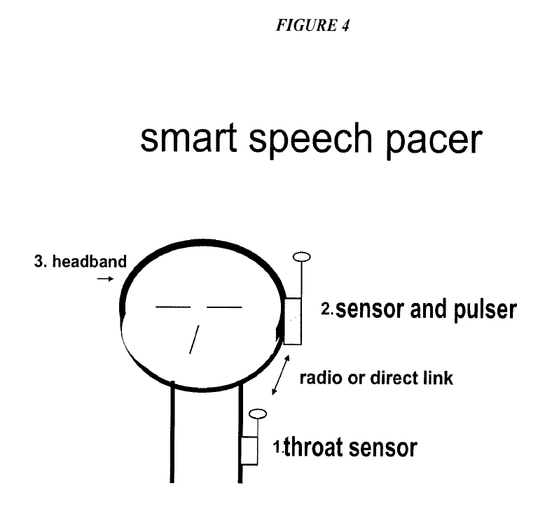

Speech motor production can likewise be entrained with rhythm. The smart speech pacer is depicted in FIG. 4.

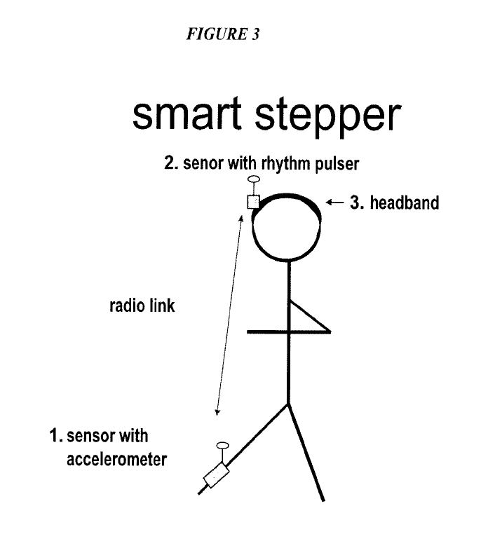

The present invention comprises the following elements: A sensor with accelerometer (FIG. 3)—an accelerometer will be attached to the ankle that will record stepping (acceleration to and from in “y” plane). This data will be transmitted to a sensor mounted on the head; A sensor mounted on the head that will trigger a pulser circuit that will deliver a rhythm related to stepping to the auditory system by either air conduction or bone conduction (or both). The pulse is a programmable device that can increase the rhythm by a percentage. Increasing the pace by <2% is not consciously detected. Increases of ˜20% are clearly perceptual; A Headband—for mounting the sensor and pulser on the head; and a throat sensor (FIG. 4)—this is substituted for the ankle sensor for entraining speech motor control.

The elements are interconnected as follows: The sensor with an accelerometer (FIG. 3 #1) will code stepping as acceleration. This data will be sent by radiowaves to the head mounted sensor and pulser (FIG. 3 #2). The pulser will extract the gait information from the acceleration of the ankle and convert it in real time to a rhythmic pulse. The pulsing will be gradually changed (˜2-4%) such that stepping will be modified to gradually increase stride length. Thus training always starts with the patient's habitual gait and trains at that point to allow neural reprogramming following conventional scientific principles. The head sensor and pulse is mounted on a head band that supplies power via a low voltage battery.

In the speech embodiment the sensor with the accelerometer is moved form the ankle to the neck (near the vocal track); otherwise the process is the same. It is also possible to use a wired accelerometer to bypass the radiowave link.

A series of processing algorithm (e.g., filtering, spectral analysis, frequency tracking) convey significant features of the gait (although all may not be used in the final device). Algorithms developed are programmed in C (or another computer language) and downloaded into the pulser. (FIG. 3 #2)

The speech embodiment consists of a series of algorithms that identify vocal fold activity (phonation) and measure the duration of an utterance (breath grouping). This will be converted into a rhythm.

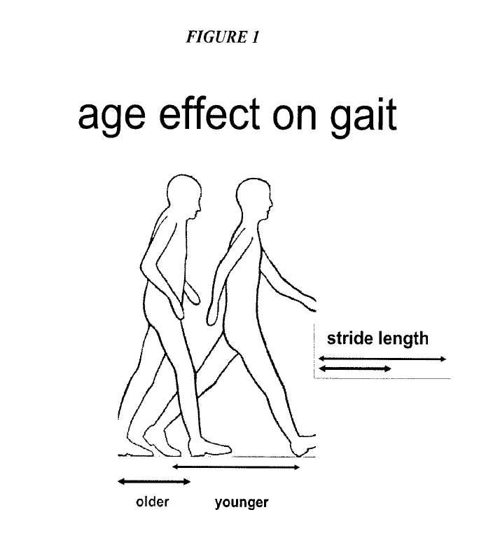

The novelty of the present invention is the use of a radiowave link as a substitute for the somatosensory cues from the feet to the brain. The rapid feed-forward will allow for more cortical and subcortical processing time. The use of rhythm will engage the auditory motor system, a neural network not normally engaged in walking or talking to provide the necessary timing cues in a damage motor system. The training in real time will enhance brain reprogramming (learning) thus speeding the normal gait recovery. Without gait training patients and the elderly will likely progress to shorter and shorter stride lengths (FIG. 1) resulting in maladaptive ankle balancing strategies with increases in the risk of serious falls.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

I claim:

1. A gait-enhancing learning device, comprising:
(a) a first sensor, comprising an accelerometer adapted for attachment to an ankle of a subject, wherein said sensor is further adapted to record stepping rhythm of a subject by monitoring of the acceleration of said accelerometer;
(b) a second sensor mounted on a head of said subject adapted to receive data from the first sensor, wherein said second sensor is further adapted to trigger a pulser circuit adapted to deliver a signal which is a function of the stepping rhythm of said subject, and wherein said second signal is delivered by air or bone conduction to a subject's ears; and
(c) a headband for mounting the second sensor and pulser on the head of said subject.

2. A device for improving gait comprising:
(a) an accelerometer for attachment to a lower extremity of a subject;
(b) a data receiver for attachment on or about the head of said subject;
(c) wherein said data receiver produces a signal corresponding to a stepping rhythm and wherein said signal is provided to the auditory system of said human.

3. The device of claim 2, wherein said signal is a function of the subject's stepping rhythm.

4. The device of claim 2, further comprising a headband for mounting the data receiver on the head of said subject.

5. The device of claim 2, wherein said signal is provided via bone or air conduction.

6. A device for entraining speech motor control, comprising a sensor adapted to monitor the actuation of a subject's vocal cords and a data receiver adapted to receive a signal from said sensor, wherein said data receiver produces a second signal that is a function of said first signal and said second signal is provided to the auditory system of said subject.

7. The device of claim 6, wherein said signal is provided via bone or air conduction.

8. A device for improving a rhythmic activity comprising an accelerometer adapted to record and transmit data relating to the accelerations caused as a result of said rhythmic activity, wherein said data is processed by a processor into the form of a rhythmic pulse and said rhythmic pulse is transmitted to a transducer disposed on a human, and further wherein said processor is adapted to change the rhythm of the pulse gradually, thereby causing entrainment of the rhythmic activity with the rhythmic pulse.

9. The device of claim 8, wherein said transducer is an air or bone conduction device.

10. The device of claim 8, wherein said rhythmic activity is gait.

11. The device of claim 8, wherein said rhythmic activity is speech.

12. The device of claim 8, wherein said accelerometer is disposed on an ankle of said subject.

13. The device of claim 8, wherein said rhythmic pulses are sent wirelessly to said transducer.

14. A method for changing the rhythm of a rhythmic activity of a subject, comprising the steps of detecting the rhythmic activity of said subject, producing a pulse correlated with the rhythm of the rhythmic activity, transmitting the pulse to a transducer disposed on said subject, and changing the rhythm of the pulse gradually to induce a change in the rhythmic activity of the subject.
